(19) United States
(12) Patent Application Publication
(10) Pub. No.: US 2026/0252124 A1
(43) Pub. Date: Aug. 27, 2026

(54) UNMANNED AERIAL VEHICLE CONTROL SYSTEM AND CONTROL DEVICE

(71) Applicant: TOYOTA JIDOSHA KABUSHIKI KAISHA, Toyota-shi (JP)

(72) Inventor: Junya KOBAYASHI, Ama-shi (JP)

(73) Assignee: TOYOTA JIDOSHA KABUSHIKI KAISHA, Toyota-shi (JP)

(21) Appl. No.: 19/413,252

(22) Filed: Dec. 9, 2025

(30) Foreign Application Priority Data
Feb. 27, 2025 (JP) 2025-030204

(51) Int. Cl. G05D 1/692; G05D 1/695; G05D 1/698; G05D 109/25

(52) U.S. Cl. CPC G05D 1/692; G05D 1/695; G05D 1/6985; G05D 2109/25

(57) ABSTRACT

An unmanned aerial vehicle control system controls an unmanned aerial vehicle to fly so as to follow a target vehicle. When a predetermined condition is satisfied, the unmanned aerial vehicle control system controls the unmanned aerial vehicle based on a trajectory-following mode, and sets, as a flight route of the unmanned aerial vehicle in the trajectory-following mode, a route that reproduces a travel trajectory of the target vehicle. The predetermined condition includes at least that the distance between the unmanned aerial vehicle and the target vehicle is greater than or equal to a threshold value.

### CROSS-REFERENCE TO RELATED APPLICATION

This application claims priority to Japanese Patent Application No. 2025-030204 filed on February 27, 2025. The disclosure of the above-identified application, including the specification, drawings, and claims, is incorporated by reference herein in its entirety.

### BACKGROUND

### 1. Technical Field

The present disclosure relates to unmanned aerial vehicle control systems for controlling an unmanned aerial vehicle that follows a vehicle, and to in-vehicle control devices for controlling an unmanned aerial vehicle.

### 2. Description of Related Art

Japanese Unexamined Patent Application Publication No. 2021-110692 (JP 2021-110692 A) discloses a system for controlling a drone to capture images of a traveling vehicle from various angles. This system is characterized in that it predicts the future traveling position of the vehicle and calculates a flight path for the drone such that the drone passes through a position relative to the vehicle that is set in advance in accordance with each situation.

### SUMMARY

In certain environments (for example, in a forest with many curves and obstacles such as trees), a control method based on the future traveling position of a vehicle, as in JP 2021-110692 A, may not function effectively. In particular, when the drone is separated from the vehicle by a large distance, the shortest route to follow the vehicle is to fly the drone directly toward the position of the vehicle. However, if there are many obstacles along that route, the drone will need to perform complex avoidance maneuvers to navigate around them.

One object of the present disclosure is to provide a technology that enables an unmanned aerial vehicle to reliably follow a vehicle, even when separated from the vehicle by a large distance, in a course having many obstacles and a complex shape.

A first aspect relates to an unmanned aerial vehicle control system.

The unmanned aerial vehicle control system includes an unmanned aerial vehicle and one or more processors configured to control the unmanned aerial vehicle to fly so as to follow a target vehicle.

The one or more processors are configured to, when a predetermined condition is satisfied, control the unmanned aerial vehicle based on a trajectory-following mode, and

set, as a flight route of the unmanned aerial vehicle in the trajectory-following mode, a route that reproduces a travel trajectory of the target vehicle.

The predetermined condition includes at least that the distance between the unmanned aerial vehicle and the target vehicle is greater than or equal to a threshold value.

A second aspect relates to a control device configured to be mounted on a vehicle.

The control device includes one or more processors configured to control an unmanned aerial vehicle to fly so as to follow the vehicle.

The one or more processors are configured to, when a predetermined condition is satisfied, control the unmanned aerial vehicle based on a trajectory-following mode, and

set, as a flight route of the unmanned aerial vehicle in the trajectory-following mode, a route that reproduces a travel trajectory of the vehicle.

The predetermined condition includes at least that the distance between the unmanned aerial vehicle and the vehicle is greater than or equal to a threshold value.

According to the technology of the present disclosure, when the predetermined condition is satisfied, the unmanned aerial vehicle is controlled in accordance with the trajectory-following mode. Specifically, in the trajectory-following mode, the unmanned aerial vehicle is controlled to fly along a route that reproduces the travel trajectory of the target vehicle (that is, so as to trace the travel trajectory). It is unlikely that obstacles hindering the flight of the unmanned aerial vehicle are present in areas the target vehicle has already passed. Therefore, the trajectory-following mode in which the unmanned aerial vehicle is controlled to fly so as to trace the travel trajectory of the target vehicle is effective in courses having many obstacles and complex shapes.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram of a drone control system;

FIG. 2 is a schematic diagram of a trajectory-following mode;

FIG. 3 is a schematic diagram showing an example of transition to a trajectory-following mode in response to a communication failure;

FIG. 4 is a flowchart showing a series of processes including a mode switching process; and

FIG. 5 is a block diagram showing an example of the configuration of the drone control system.

### DETAILED DESCRIPTION OF EMBODIMENTS

An embodiment of the present disclosure will now be described with reference to the drawings. In the present embodiment, a drone 20 is taken as a typical example of an unmanned aerial vehicle. Accordingly, an unmanned aerial vehicle control system will be described as a drone control system 1. The term "unmanned aerial vehicle" is a concept that includes, in addition to drones, unmanned airplanes and unmanned helicopters. The drone 20 is configured to fly autonomously.

### 1. Drone Control System

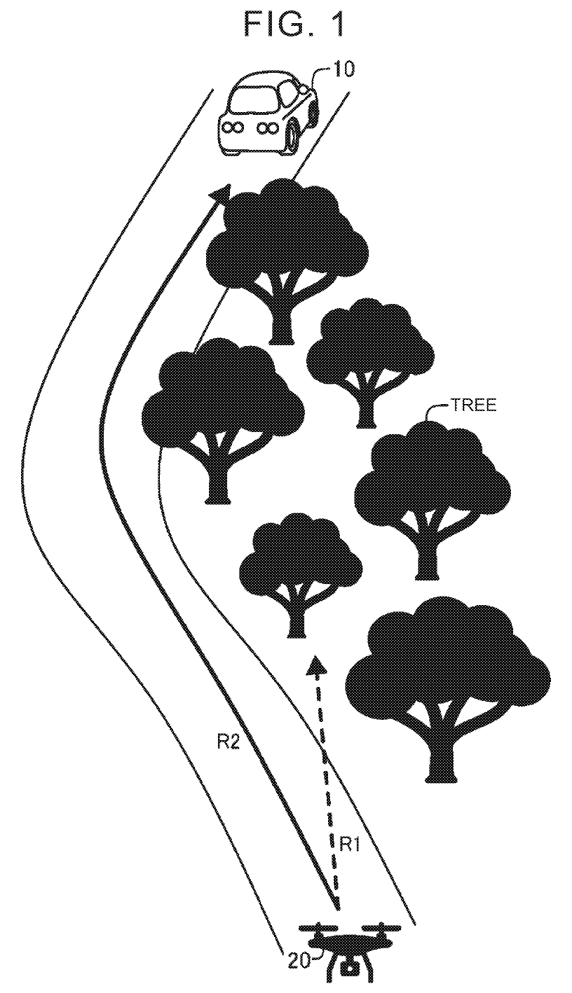

FIG. 1 is a schematic diagram of the drone control system 1. The drone 20 flies so as to follow a target vehicle 10. When the distance between the target vehicle 10 and the drone 20 increases and the drone 20 attempts to catch up with the target vehicle 10, the theoretically shortest route is to proceed straight toward the current position of the target vehicle 10, as in a route R1. However, with such control, when the target vehicle 10 is traveling in an environment with many obstacles (such as trees and rocks) and curves, for example, on a mountain road, the risk of the drone 20 colliding with an obstacle increases.

Alternatively, the drone 20 may frequently perform avoidance maneuvers to navigate around obstacles, which tends to make its flight behavior more complex. As a result, such control may actually increase the time it takes for the drone 20 to catch up with the target vehicle 10. In addition, in order to reliably perform such complex maneuvers, a stable communication environment is also desired to prevent or reduce control delays.

In such a case, a route R2 for directly following the travel trajectory of the target vehicle 10 is considered to be a more reliable method. Since there are basically no obstacles along the path the target vehicle 10 has already passed, unnecessary avoidance maneuvers can be reduced. This control mode for directly following the travel trajectory of the target vehicle 10 is referred to as "trajectory-following mode." By selectively switching between the trajectory-following mode and a different normal mode, the drone control system 1 can control the drone 20 to reliably follow the target vehicle 10 even in environments with many obstacles and curves. The normal mode is a conventional control mode, and typically refers to a mode in which the drone is controlled to fly at a specific relative position with respect to the target vehicle 10 (for example, 5 m behind and 2 m above).

### 2. Trajectory-Following Mode

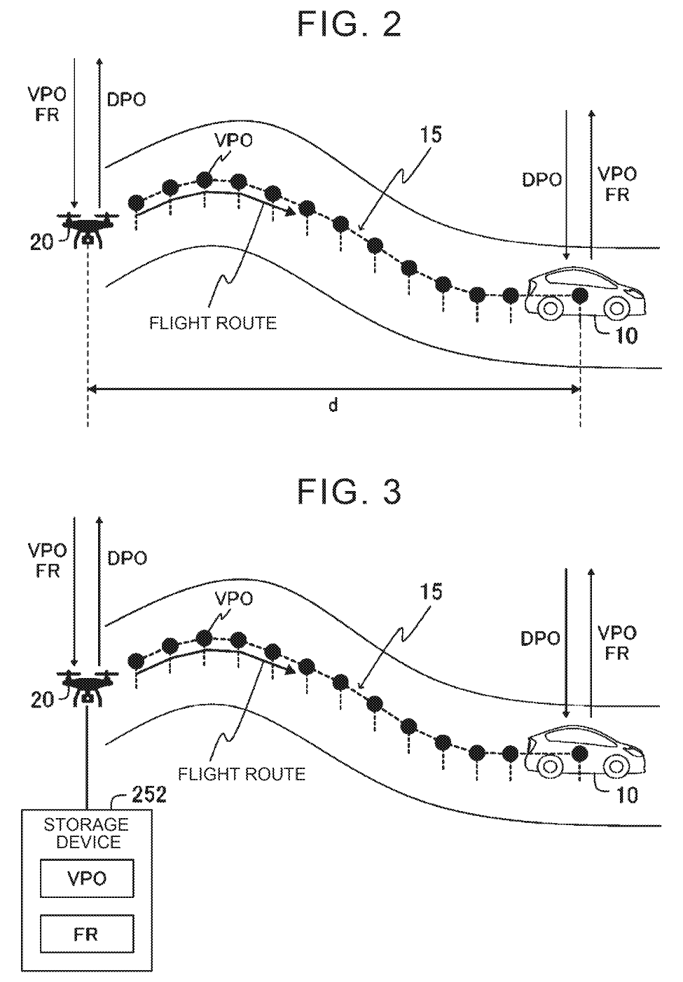

FIG. 2 is a schematic diagram of the trajectory-following mode. In the trajectory-following mode, the drone control system 1 sets, as the flight route of the drone 20, a route that reproduces a travel trajectory 15 of the target vehicle 10. Specifically, the drone control system 1 acquires vehicle position information VPO of the target vehicle 10 and sets a flight route based on the acquired vehicle position information VPO. The flight-route generation may be performed by the target vehicle 10 or by the drone 20 that has acquired the vehicle position information VPO. The flight-route generation may alternatively be performed by an external server capable of communicating with the target vehicle 10 or the drone 20. The flight route is absolute or relative coordinate information that indicates the path along which the drone 20 will fly. In the trajectory-following mode, the flight route is set such that the drone 20 faithfully follows the travel trajectory 15 of the target vehicle 10. Regarding the position of the target vehicle 10, following both the horizontal and vertical positions of the target vehicle 10 is suitable as a route for avoiding obstacles. The position of the target vehicle 10 refers to, for example, the center position of the target vehicle 10.

The drone control system 1 calculates the flight route using the vehicle position information VPO. Such information is associated with time. That is, as shown in the figure, the drone control system 1 acquires the position (travel trajectory 15) of the target vehicle 10 at each point in time. The drone control system 1 reproduces the travel trajectory 15 as the flight route in the trajectory-following mode.

When calculating the flight route, the drone control system 1 may use drone position information DPO indicating the position of the drone 20. In this case, the drone control system 1 refers to the current position of the drone 20 and calculates how far the drone 20 should move from its current position. The drone position information DPO is acquired by the drone 20 using a satellite system etc. However, like the vehicle position information VPO, the drone position information DPO may be shared via communication with the target vehicle 10 or an external server. Alternatively, the drone 20 may receive flight route information FR that is information on the flight route calculated using the vehicle position information VPO and the drone position information DPO.

### 2-1. Condition for Transition to Trajectory-Following Mode

The drone control system 1 executes a "mode switching process" of switching between the normal mode and the trajectory-following mode. As a general rule, when the distance d between the target vehicle 10 and the drone 20 becomes greater than or equal to a threshold value, the drone control system 1 switches the control mode from the normal mode to the trajectory-following mode. When the distance d is long, it means that obstacles or curves that hinder the drone 20 from directly flying toward the target vehicle 10 to catch up are more likely to appear. Therefore, it is reasonable to switch to the trajectory-following mode in which a flight route with fewer obstacles is set, when the distance d becomes large. A method for measuring the distance d will be described in Section 3 together with the configuration of the target vehicle 10 and the drone 20.

A condition for transitioning to the trajectory-following mode may include that a communication failure occurs during communication performed when the drone 20 acquires the vehicle position information VPO. The communication failure as used herein includes interruption or delay of communication. The occurrence of a communication failure means that tracking using real-time vehicle position information VPO or drone position information DPO becomes difficult, and as a result, the distance d tends to increase. In other words, a communication failure can be regarded as a precursor to an increase in the distance d. In such a case, it makes sense to switch to the trajectory-following mode in advance and adopt a more reliable flight route. FIG. 3 is a schematic diagram showing an example of transition to the trajectory-following mode in response to a communication failure. The drone 20 cannot acquire real-time information during a communication failure. It is therefore preferable that, in a normal state (when communication is possible), the drone 20 at least temporarily hold flight route information FR and vehicle position information VPO in a storage device 252. That is, by using each piece of information acquired by the drone 20 before the occurrence of the communication failure, the drone control system 1 can control the drone 20 even during the communication failure.

### 2-2. Flow of Mode Switching Process

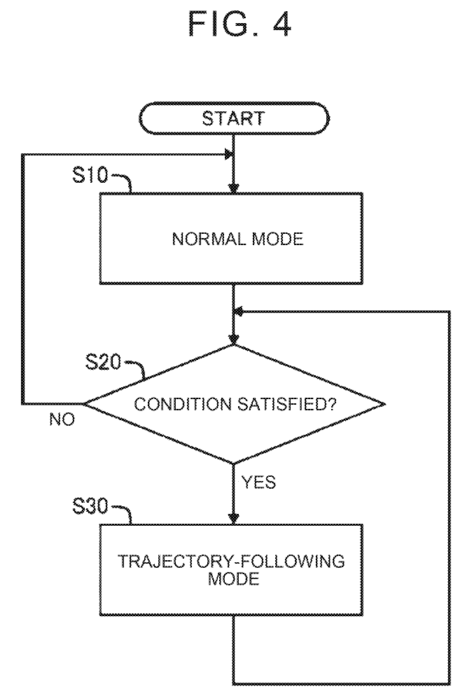

FIG. 4 is a flowchart showing a series of processes including the mode switching process.

In step S10, the drone control system 1 controls the drone 20 in the normal mode. The process then proceeds to step S20.

In step S20, the drone control system 1 determines whether a predetermined condition is satisfied. As described above, the predetermined condition includes that the distance d between the target vehicle 10 and the drone 20 is greater than or equal to the threshold value, or that a communication failure occurs. When the predetermined condition is satisfied (step S20; Yes), the process proceeds to step S30. When the predetermined condition is not satisfied (step S20; No), the process returns to step S10.

In step S30, the drone control system 1 controls the drone 20 in the trajectory-following mode. The process then returns to step S20. That is, step S20 also means that, even after the control mode has been switched to the trajectory-following mode, the process returns to step S10 and the control mode is switched back to the normal mode when the predetermined condition is no longer satisfied. In this way, the normal mode and the trajectory-following mode are selectively used depending on the situation.

### 3. Configuration Example

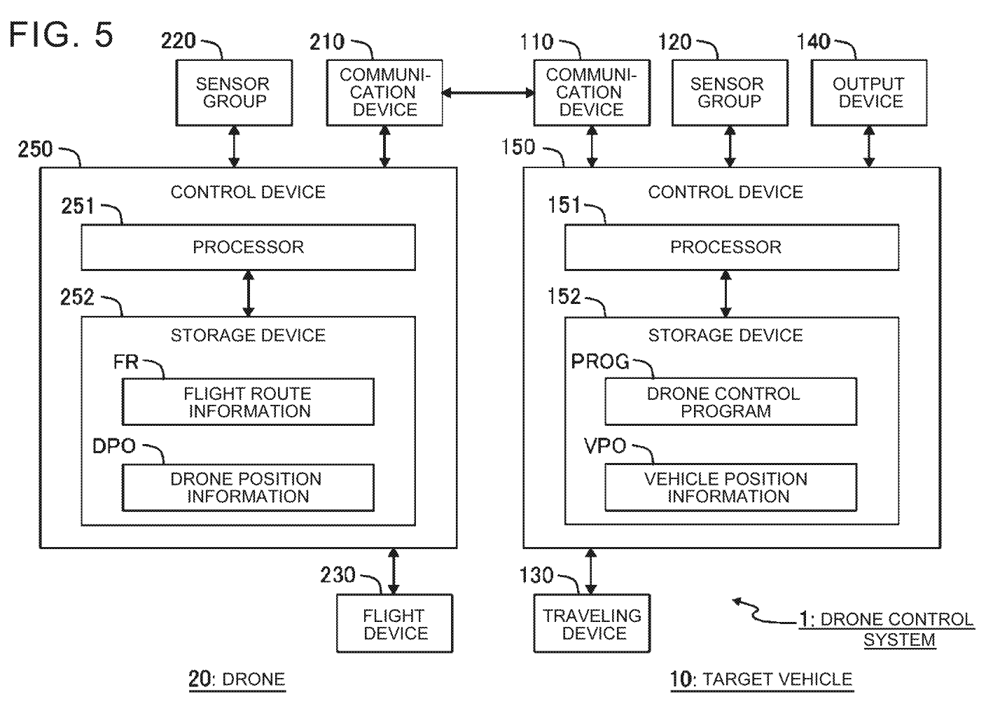

FIG. 5 is a block diagram showing an example of the configuration of the drone control system 1.

### 3-1. Target Vehicle

The target vehicle 10 includes a communication device 110, a sensor group 120, a traveling device 130, an output device 140, and a control device 150.

The communication device 110 transmits and receives information used for the mode switching process by communicating with external devices. For example, the communication device 110 transmits and receives information to and from the drone 20 through wireless communication. Various wireless communication standards can be used for the drone control system 1. Accordingly, an optimal communication standard can be selected depending on the situation from the viewpoints of communication distance, communication speed, power consumption, cost, etc. The communication device 110 receives radio waves from satellites or base stations for self-positioning. The communication device 110 also receives signals from satellites and base stations for self-positioning. The communication device 110 uses, for example, a global navigation satellite system (GNSS) for self-positioning. The GNSS used in the drone control system 1 may employ not only a general single-point positioning method but also a relative positioning method. One known example of a relative positioning method is real-time kinematic (RTK) positioning. In RTK positioning, two receivers, one at a reference station with a known position and one at a rover station as the positioning target, receive signals, and the position information of the reference station is wirelessly transmitted to the rover station. RTK positioning is characterized in that, based on the position information of a reference station, the rover station corrects errors to improve accuracy, thereby obtaining position information with higher accuracy than single-point positioning. While the measurement error of single-point positioning is on the order of several meters, RTK positioning can reduce the measurement error to the order of several centimeters. In the trajectory-following mode, it is desirable for the drone 20 to accurately trace the travel trajectory 15 of the target vehicle 10. Therefore, positioning in the trajectory-following mode is preferably performed using the RTK positioning method.

The sensor group 120 includes recognition sensors and vehicle state sensors. The recognition sensors recognize (detect) the surroundings of the target vehicle 10. Examples of the recognition sensors include an in-vehicle camera, a Light Detection and Ranging (LiDAR), and a radar. The vehicle state sensors detect the state of the target vehicle 10. Examples of the vehicle state sensors include a speed sensor, an acceleration sensor, a yaw rate sensor, and a steering angle sensor.

The traveling device 130 includes a steering device, a drive device, and a braking device. The steering device steers the wheels. For example, the steering device includes an electric power steering (EPS) device. The drive device is a power source that generates driving force. Examples of the drive device include an engine, an electric motor, and an in-wheel motor. The braking device generates braking force.

The output device 140 outputs various types of information. For example, the output device 140 includes a display device. The display device presents various types of information to the driver of the target vehicle 10 by displaying the information. As another example, the output device 140 may include a speaker. When transitioning to the trajectory-following mode, the drone control system 1 may provide a notification via the output device 140 to inform the driver of the transition. This allows the driver to recognize that the target vehicle 10 and the drone 20 are considerably far apart and to take measures such as stopping or decelerating the target vehicle 10 until the drone 20 approaches sufficiently close to the target vehicle 10.

The control device 150 includes one or more processors 151 (hereinafter simply referred to as "processor 151") and a storage device 152. The processor 151 executes the mode switching process. Examples of the processor 151 include a general-purpose processor, an application-specific processor, a central processing unit (CPU), a graphics processing unit (GPU), an application-specific integrated circuit (ASIC), a field programmable gate array (FPGA), an integrated circuit, a conventional circuit, and/or combinations thereof. The processor 151 may also be referred to as circuity or processing circuitry.

The storage device 152 stores various types of information. Examples of the storage device 152 include a volatile memory, a nonvolatile memory, a hard disk drive (HDD), and a solid state drive (SSD). The functions of the control device 150 are implemented by cooperation between the processor 151 and the storage device 152. The storage device 152 stores a drone control program PROG. The functions of the drone control system 1 are implemented by the processor 151 executing the drone control program PROG. The drone control program PROG may be recorded on a computer-readable recording medium. The storage device 152 also stores the vehicle position information VPO.

### 3-2. Drone

The drone 20 includes a communication device 210, a sensor group 220, a flight device 230, and a control device 250.

The communication device 210 transmits and receives information used for the mode switching process by communicating with external devices. For example, the communication device 210 transmits and receives information to and from the target vehicle 10 through wireless communication. The communication device 210 receives radio waves from satellites or base stations for self-positioning. The communication device 210 uses GNSS for self-positioning. As with the target vehicle 10, positioning of the drone 20 in the trajectory-following mode is preferably performed using the RTK positioning method.

The sensor group 220 includes attitude control sensors, ranging sensors, geomagnetic sensors, etc. The attitude control sensors are sensors used for controlling the attitude of the drone 20, and include an angular velocity sensor and an acceleration sensor. The ranging sensors include a vision sensor built into a camera, an ultrasonic sensor, a LiDAR, etc., and are used to measure the distance d to the target vehicle 10. That is, the drone control system 1 determines, based on the distance d detected by the ranging sensors, whether the condition related to the mode switching process is satisfied. The ranging sensors are also used to measure the distance between the drone 20 and the ground surface, and are used for altitude control of the drone 20. The geomagnetic sensors detect the orientation of the drone 20.

The flight device 230 is a power source (e.g., an electric motor) that generates lift. The flight device 230 is connected to propellers, and generates lift by rotating the propellers. Mounting a flight device 230 on each propeller allows each propeller to exhibit different rotational behaviors. Accordingly, fine-grained attitude control and flight control such as hovering, turning, ascending/descending, and lateral movement become possible.

The control device 250 includes one or more processors 251 (hereinafter simply referred to as "processor 251") and a storage device 252. The processor 251 executes the mode switching process. Examples of the processor 251 include a general-purpose processor, an application-specific processor, a CPU, a GPU, an ASIC, an FPGA, an integrated circuit, a conventional circuit, and/or combinations thereof. The processor 251 may also be referred to as circuity or processing circuitry.

The storage device 252 stores various types of information. Examples of the storage device 252 include a volatile memory, a nonvolatile memory, a hard disk drive (HDD), and a solid state drive (SSD). The functions of the control device 250 are implemented by cooperation between the processor 251 and the storage device 252. The storage device 252 includes the drone position information DPO and the flight route information FR.

### 3-3. Others

The target vehicle 10 and the drone 20 may communicate via an external server. Specifically, the communication device 110 and the communication device 210 may communicate with each other via the external server. Part or all of the processing related to the drone control system 1 may be executed by the external server. For example, the external server may acquire the vehicle position information VPO from the target vehicle 10 and the drone position information DPO from the drone 20, and then generate a flight route. The external server may further transmit the generated flight route to the drone 20 as flight route information FR.

What is claimed is:

1. An unmanned aerial vehicle control system comprising:
an unmanned aerial vehicle; and
one or more processors configured to control the unmanned aerial vehicle to fly so as to follow a target vehicle, wherein:
the one or more processors are configured to, when a predetermined condition is satisfied,
control the unmanned aerial vehicle based on a trajectory-following mode, and
set, as a flight route of the unmanned aerial vehicle in the trajectory-following mode, a route that reproduces a travel trajectory of the target vehicle; and
the predetermined condition includes at least that a distance between the unmanned aerial vehicle and the target vehicle is greater than or equal to a threshold value.

2. The unmanned aerial vehicle control system according to claim 1, wherein:
the unmanned aerial vehicle includes a communication device and a storage device;
the communication device is configured to acquire, via communication, vehicle position information indicating a position of the target vehicle;
the storage device is configured to at least temporarily hold the acquired vehicle position information;
the predetermined condition further includes that a communication failure occurs during the communication performed to acquire the vehicle position information; and
in the trajectory-following mode, the one or more processors are configured to reproduce the travel trajectory of the target vehicle based on the vehicle position information held in the storage device.

3. The unmanned aerial vehicle control system according to claim 1, wherein, in the trajectory-following mode, the one or more processors are configured to notify a driver of the target vehicle that the unmanned aerial vehicle is being controlled based on the trajectory-following mode.

4. A control device configured to be mounted on a vehicle, the control device comprising one or more processors configured to control an unmanned aerial vehicle to fly so as to follow the vehicle, wherein:
the one or more processors are configured to, when a predetermined condition is satisfied,
control the unmanned aerial vehicle based on a trajectory-following mode, and
set, as a flight route of the unmanned aerial vehicle in the trajectory-following mode, a route that reproduces a travel trajectory of the vehicle; and
the predetermined condition includes at least that a distance between the unmanned aerial vehicle and the vehicle is greater than or equal to a threshold value.
